(19) United States
(12) Patent Application Publication
(10) Pub. No.: US 2026/0146873 A1
(43) Pub. Date: May 28, 2026

(54) Demisting Sensor System

(71) Applicant: Illinois Tool Works Inc., Glenview, IL (US)

(72) Inventors: Edward Mehall, Geneva, IL (US); Piotr Sliwa, Arlington Heights, IL (US); Scott Bair, Skokie, IL (US); Marian Cristea, City Ghimbav (DE); Fredrik Andersson, Vasteras (SE); Zsolt Wilke, Bad Mergentheim (DE); Bradley Stecker, McHenry, IL (US); Jeanne Baspeyras, Paris (FR)

(21) Appl. No.: 19/389,514

(22) Filed: Nov. 14, 2025

Related U.S. Application Data
(60) Provisional application No. 63/723,971, filed on Nov. 22, 2024.
(60) Provisional application No. 63/723,978, filed on Nov. 22, 2024.

(51) Int. Cl. G01D 11/26; B60H 1/24; B60S 1/56; H04N 23/51

(52) U.S. Cl. CPC G01D 11/26; B60H 1/242; B60S 1/56; H04N 23/51

(57) ABSTRACT

Disclosed is sensor system for use with a windshield that defines at least a partially transparent region. The sensor system includes a glare shield and at least one sensor. The glare shield can be positioned adjacent to the windshield to define a sensor cavity therebetween. The at least one sensor can be disposed within the sensor cavity and oriented with a field of view through the transparent region of the windshield. In some examples, a moisture-trapping material is disposed within the sealed sensor cavity and configured to absorb or adsorb moisture to control humidity and reduce condensation within the sealed sensor cavity. In some examples, the glare shield defines an airflow path through the sensor cavity between an airflow inlet and an airflow outlet to reduce or prevent moisture accumulation within the sensor cavity.

### RELATED APPLICATION

The present application claims priority to U.S. Provisional Patent Application No. 63/723,971, filed Nov. 22, 2024, and U.S. Provisional Patent Application No. 63/723,978, filed Nov. 22, 2024, each of which is hereby incorporated by reference in its entirety.

### BACKGROUND

Vehicular safety systems are increasingly being developed to assist drivers in maintaining vehicle control and awareness. One such system, commonly referred to as a lane departure warning (LDW) system, is configured to determine whether a vehicle is being maintained within a designated lane on a roadway and, if not, to provide a warning to the driver.

LDW systems may employ one or more sensors, such as cameras, mounted within the vehicle compartment. In many examples, the camera is positioned between the center rearview mirror and the windshield so that its field of view encompasses the roadway ahead of the vehicle. A glare shield may be positioned between the camera and the windshield to prevent stray light, originating outside the camera's intended field of view, from adversely affecting image acquisition.

Other types of sensors are also being developed for use in advanced driver-assistance systems (ADAS) capable of detecting pedestrians, other vehicles, and obstacles in the vehicle's vicinity. Such sensors enable the vehicle to automatically control its acceleration and braking to maintain appropriate spacing relative to surrounding objects. Continued advancements in these technologies are expected to support semi-autonomous and fully autonomous vehicle operation.

Sensors used for these purposes may include, for example, radar, LIDAR, infrared imaging, visible-light imaging, or ultrasonic sensors. The performance of these sensors can be adversely affected by environmental conditions, such as the accumulation of ice, sleet, or snow, which can obstruct the sensor's field of view or otherwise degrade signal transmission and reception. The use of protective shields or covers in front of the sensor may also interfere with its operation. In particular, radar sensors may be affected by conductive materials, such as metallic heating elements, positioned over the sensor, as these materials can attenuate or block radio wave propagation.

Cameras used for LDW systems rely on clear image signals to detect lane markings and determine the vehicle's position relative to those markings. Image quality can deteriorate when frost, ice, or fog forms on the windshield or other optical surfaces in the camera's field of view. Condensation may also develop within the sealed housing that contains the sensor array due to differences in temperature and humidity. The formation of fog or mist within the housing can obstruct the optical path of the sensor. One known method for reducing condensation involves heating the area surrounding the sensor to evaporate accumulated moisture. For example, heat applied near the glare shield may induce convective air movement that removes vapor from the sensor's field of view. However, such heating requires additional electrical power and may extend the warm-up time of the system.

Accordingly, there remains a need for systems and methods that mitigate or prevent the formation of fog, condensation, or mist over vehicle-mounted sensors—particularly those used in LDW and related ADAS applications—while reducing or eliminating the reliance on power-intensive heating elements.

### SUMMARY

The present disclosure relates generally to a demisting sensor system, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1A illustrates a vehicle equipped with one or more sensor systems.

FIG. 1B illustrates an assembled cross-sectional perspective view of an example sensor system, taken along cut line A-A of FIG. 1A.

FIG. 2 illustrates an assembled cross-sectional side elevation view of a sensor system, in accordance with one aspect of the subject disclosure, taken along cut line A-A of FIG. 1A.

FIGS. 3A through 3C illustrate assembled cross-sectional side elevation views of a sensor system, in accordance with additional aspects of the subject disclosure, taken along cut line A-A of FIG. 1A.

FIG. 4 illustrates an assembled cross-sectional side elevation view of a sensor system, in accordance with yet another aspect of the subject disclosure, taken along cut line A-A of FIG. 1A.

FIGS. 5A and 5B illustrate assembled cross-sectional side elevation views of a sensor system incorporating a moisture-absorption feature, in accordance with additional aspects of the subject disclosure, taken along cut line A-A of FIG. 1A.

FIGS. 6A through 6D illustrate assembled cross-sectional side elevation views of example moisture-absorption feature arrangements, in accordance with additional aspects of the subject disclosure, taken along cut line B-B of FIG. 5A.

FIGS. 7A and 7B illustrate assembled cross-sectional side elevation views of a sensor system including, respectively, a microporous layer and a moisture-absorption layer, in accordance with additional aspects of the subject disclosure, taken along cut line A-A of FIG. 1A.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed is a demisting sensor system for use with a component of a vehicle, such as a windshield.

In a first example, a sensor system for use with a windshield that defines an at least partially transparent region comprises: a glare shield configured to be positioned adjacent to the windshield to define a sensor cavity therebetween; and at least one sensor configured to be disposed within the sensor cavity and oriented with a field of view through the at least partially transparent region of the windshield; wherein the glare shield defines an airflow path through the sensor cavity between an airflow inlet and an airflow outlet to mitigate moisture accumulation within the sensor cavity.

In some examples, the sensor system further comprises a heating, ventilation, and air conditioning (HVAC) unit configured to direct airflow along the airflow path.

In some examples, the HVAC unit is configured to generate an air stream that induces a pressure differential across the sensor cavity.

In some examples, the sensor system further comprises a diffuser positioned proximate to the airflow outlet configured to draw air through the sensor cavity.

In some examples, the sensor system further comprises a heater assembly disposed adjacent to the glare shield and configured to preheat airflow entering the sensor cavity.

In some examples, the sensor system further comprises at least one filter component positioned at the airflow inlet and configured to filter airflow at the airflow inlet.

In some examples, the filter component comprises at least one of: a fiberglass filter, a pleated media filter, a passive electrostatic filter, or a HEPA filter.

In some examples, the sensor cavity includes a light-baffle structure configured to block light at the airflow inlet.

In some examples, the airflow path traverses along an interior surface of the windshield to reduce fogging or condensation at the at least partially transparent region.

In some examples, the HVAC unit is configured to regulate at least one of airflow velocity, temperature, and/or direction through the sensor cavity.

In a second example, a sensor system for use with a windshield that defines an at least partially transparent region comprises: a glare shield configured to be positioned adjacent to the windshield to define a sealed sensor cavity therebetween; at least one sensor configured to be disposed within the sealed sensor cavity and oriented with a field of view through the at least partially transparent region of the windshield; and a moisture-trapping material disposed within the sealed sensor cavity and configured to absorb or adsorb moisture to control humidity and reduce condensation within the sealed sensor cavity.

In some examples, the moisture-trapping material comprises silica gel, molecular sieve materials, zeolite, activated alumina, or calcium chloride-based desiccants.

In some examples, the moisture-trapping material is contained within a permeable enclosure or vented housing positioned in a lower region of the sealed sensor cavity to facilitate passive humidity control.

In some examples, the sensor system further comprises a vapor-permeable membrane disposed within the sealed sensor cavity, the vapor-permeable membrane being configured to allow water vapor transmission toward the moisture-trapping material.

In some examples, the sealed sensor cavity is defined by a continuous seal between the glare shield and the windshield to prevent external fluid ingress.

In some examples, the sensor system further comprises a heater assembly configured to raise a temperature within the sealed sensor cavity.

In some examples, the at least one sensor is a camera, lidar sensor, or infrared detector.

In a third example, a housing assembly for a sensor system configured for use with a windshield having an at least partially transparent region comprises: a glare shield configured to be positioned adjacent to the windshield to define a sealed sensor cavity therebetween, wherein the glare shield comprises a first glare panel and a second glare panel oriented transversely relative to one another, wherein each of the first glare panel and the second glare panel comprises a heater layer configured to provide a dual-plane heater arrangement, wherein at least one sensor is configured to be disposed within the sealed sensor cavity and oriented with a field of view through the at least partially transparent region of the windshield, and wherein the sealed sensor cavity is defined by a continuous seal between the glare shield and the windshield to prevent external fluid ingress.

In some examples, the sensor system further comprises a moisture-trapping material disposed within the sealed sensor cavity and configured to absorb or adsorb moisture in the sealed sensor cavity.

In some examples, the moisture-trapping material is contained within a permeable enclosure or vented housing positioned of the sealed sensor cavity to facilitate passive humidity control.

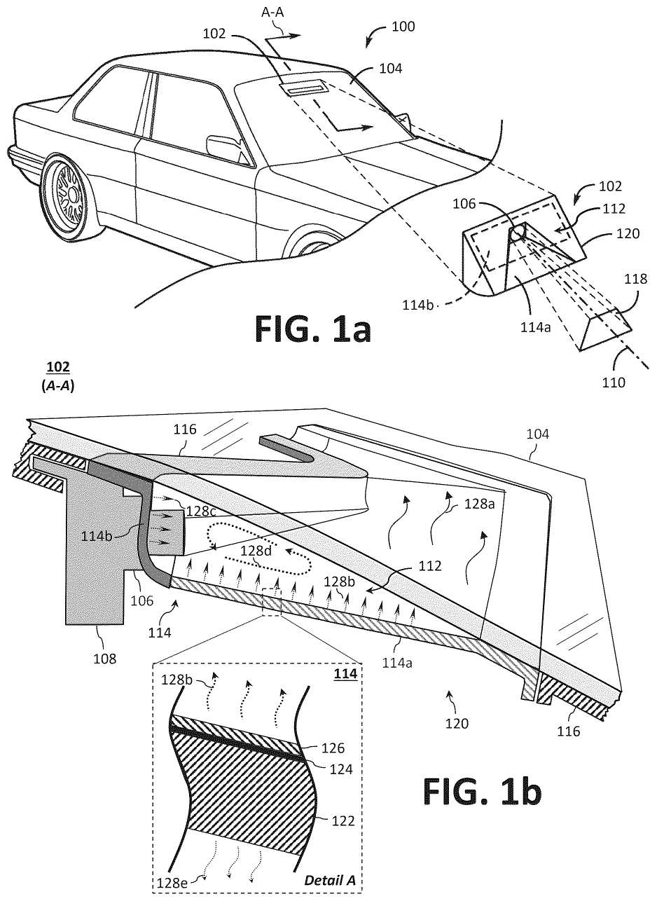

FIG. 1a illustrates a vehicle 100 equipped with one or more sensor systems 102, which may be positioned at various locations on the vehicle 100 to provide environmental sensing, detection, or monitoring functionality. The sensor systems 102 can include, for example, optical, radar, lidar, or ultrasonic sensors, each housed within a housing assembly 120 that provides mechanical support, environmental protection, and integration with vehicle structures. The housing assembly 120 may be configured to maintain the operational stability of the sensors across a wide range of environmental conditions, including extreme temperatures, humidity, and vibration. FIG. 1b illustrates an assembled cross-sectional perspective view of an example sensor system 102, taken along cut line A-A of FIG. 1a. As illustrated, the sensor system 102 includes the housing assembly 120 configured to support and protect various internal optical and electronic components and to incorporate environmental control features for mitigating condensation, frost, and particulate contamination on the optical surfaces of the sensor system 102.

The one or more sensor systems 102 can be positioned in or on various portions of a structural element of the vehicle 100. In the illustrated example, the vehicle 100 includes a windshield 104, and one or more of the sensor systems 102 are mounted to or integrated with the windshield 104. Each sensor system 102 may include a sensor payload 106 configured to monitor one or more aspects of the environment surrounding the vehicle 100, such as detecting obstacles, determining distances, identifying traffic signs, recognizing lane markings, or monitoring ambient lighting conditions. In one example, the sensor system 102 is configured to provide lane departure warning (LDW) functionality and may be positioned proximate a top-center region of the windshield 104. LDW capability, however, represents merely one implementation, and the disclosed sensor system 102 and associated features disclosed herein can be used for a variety of perception or driver-assistance applications.

The sensor payload 106 is configured to exchange electrical signals with a sensor interface circuit, which can communicate with a vehicular control unit (e.g., an electronic control unit (ECU)) of the vehicle 100. The vehicular control unit may process sensor data to perform various autonomous or semi-autonomous functions such as steering control, braking assistance, adaptive cruise control, and collision avoidance. Additionally, the sensor payload 106 may interface with cockpit display systems to present visual or auditory alerts to vehicle occupants, such as lane departure warnings, obstacle detection indications, or traffic sign recognition cues.

While the subject disclosure is primarily described in connection with a sensor system 102 mounted on an interior side of the windshield 104, the same principles and design considerations can be applied to sensor systems 102 positioned on other exterior or interior vehicle components, such as bumpers, grilles, side mirrors, or roof modules. The sensor payload 106 can include one or more perception sensors configured to detect, classify, and interpret the vehicle's surrounding environment.

The sensor payload 106 may be secured within a sensor housing 108, which is in turn coupled to or integrated with the housing assembly 120. The sensor housing 108 can be composed of a rigid polymer, glass-filled thermoplastic, aluminum alloy, or composite material, providing structural rigidity and thermal stability. The housing 108 may include precision alignment or registration features to position the sensor payload 106 at a desired focal distance and orientation relative to the windshield 104. The housing 108 can further include environmental sealing features—such as gaskets, O-rings, or ultrasonic welds—to prevent the ingress of moisture and debris while allowing thermal dissipation from internal electronic components.

The illustrated sensor system 102 positions the sensor payload 106 at least partially within the housing assembly 120, with a view axis 110 oriented forward toward the roadway. The sensor payload 106 is configured to detect features or objects within a field of view 118 extending about the view axis 110. The housing assembly 120 includes a glare shield 114 and a structural bracket 116, among other components. The glare shield 114 defines a sensor cavity 112 that surrounds or partially encloses the sensor payload 106, blocking or attenuating incident light from off-axis or high-angle sources that fall outside the desired field of view 118. This arrangement minimizes optical interference, ghosting, and glare, thereby improving image quality and measurement precision.

With continued reference to FIG. 1b, the glare shield 114 includes a first glare panel 114a (for example, a lower or generally horizontal panel) extending between the windshield 104 and the sensor payload 106, and a second glare panel 114b (for example, a generally vertical panel) extending between an upper portion of the sensor payload 106 and the windshield 104. The first and second glare panels 114a, 114b may diverge from one another in a direction extending from the sensor payload 106 toward the windshield 104, generally following but not obstructing the optical cone defining the field of view 118 of the sensor payload 106 about the view axis 110. An optical cone is mentioned, other shapes are contemplated, such as a trapezoidal prism. The sensor cavity 112 is enclosed or substantially enclosed on one side by the windshield 104, thereby creating a sealed or semi-sealed optical environment between the glare shield 114 and the windshield 104.

With reference to Detail A of FIG. 1b, each of the glare panels 114a, 114b of the glare shield 114 may include a layered construction comprising a base layer 122, a heater layer 124, and an anti-glare layer 126, and may optionally include additional functional layers, such as moisture-control or optical-filtration layers, as discussed in later sections.

The base layer 122 provides mechanical strength and may be formed from a polymeric, metallic, or composite substrate. The anti-glare layer 126 can be formed from a matte-finished or absorptive material configured to reduce reflectivity and prevent stray light from entering the sensor cavity 112. Suitable materials for the anti-glare layer 126 include black anodized aluminum, dark-colored polycarbonate, or glass-fiber-reinforced composites coated with a low-gloss, light-absorptive finish. The heater layer 124 may be composed of one or more resistive heating elements or traces arranged in a defined pattern to ensure even thermal distribution.

The one or more of the layers of the first and second glare panels 114a, 114b can be separate layers stacked upon one another or permanently bonded to one another (e.g., co-molded, embedded, etc.). For example, the heater layer 124 and the anti-glare layer 126 can be attached to one another and/or the base layer 122 via adhesive. In some examples, the adhesive is a peel-away adhesive that allows for the heater layer 124 and the anti-glare layer 126 to be removed from the base layer 122 for maintenance, replacement, or recyclability upon end of life. In another example, the heater layer 124 and/or the anti-glare layer 126 (or portions thereof) may be embedded in the base layer 122. For example, the traces of the heater layer 124 could be embedded in the base layer 122.

Portions of the glare shield 114, such as the base layer 122 and the anti-glare layer 126, may be manufactured using injection-molding, thermoforming, or additive manufacturing techniques. The materials may include dark-colored thermoplastics such as acrylonitrile butadiene styrene (ABS), polycarbonate (PC), or blends thereof, optionally with matte or textured finishes to suppress specular reflection. Metallic coatings, conductive polymer films, or anti-static finishes may also be employed to prevent dust accumulation within the optical path.

In the illustrated example, each of the glare panels 114a, 114b of the glare shield 114 incorporates the heater layer 124 configured to provide localized heating of the sensor cavity 112. As illustrated, the first glare panel 114a directs heat into the sensor cavity 112 from one direction, represented by arrows 128b, while minimizing heat conduction toward the vehicle cabin (arrows 128e). Likewise, the second glare panel 114b directs heat into the sensor cavity 112 from another direction, as indicated by arrows 128c. The respective heating vectors of the first and second glare panels 114a, 114b are oriented transversely, creating a “dual-plane” heater arrangement that provides both direct radiant heating and secondary convective heating within the sensor cavity 112 (represented by arrows 128d). This configuration enhances heating performance by promoting even air circulation and temperature distribution within the sensor cavity 112.

The geometry of the glare shield 114 may be optimized to conform to the optical field-of-view boundaries of the sensor payload 106, providing effective shading while maintaining a clear optical path. In addition to glare suppression, the glare shield 114 enhances optical and thermal stability by limiting direct solar radiation, reducing localized temperature gradients, and preventing particulate or moisture accumulation on the optical window adjacent the sensor payload 106. In certain examples, the glare shield 114 may further function as a structural support or alignment component, ensuring proper registration of the sensor payload 106 relative to the windshield 104 and minimizing internal reflections between the inner and outer glass surfaces.

The perception sensors contained within the sensor payload 106 can include, without limitation, cameras, LiDAR sensors, radar units, and ultrasonic transducers. In the illustrated example, a camera-based payload is shown. Cameras may be monocular units capturing color imagery for object and lane detection, stereo units providing depth information for three-dimensional scene reconstruction, or wide-angle cameras used for surround-view monitoring. Other examples include infrared cameras for night vision, time-of-flight sensors for depth measurement, and event-based cameras for dynamic object tracking in high-speed environments.

The sensor payload 106 can also incorporate LiDAR sensors configured to emit laser pulses to generate high-resolution three-dimensional point clouds of the environment, or radar sensors that determine the distance, velocity, and relative motion of objects via radio frequency reflections. Radar examples can include short-, medium-, and long-range variants, respectively suited for blind-spot detection, cross-traffic alerts, and adaptive cruise control functions. Ultrasonic sensors may further complement the system by providing short-range object detection for low-speed maneuvering or parking assistance.

The heater layer 124, which may take the form of a flexible film or printed heater sheet, includes a plurality of resistive traces forming a heater array. In some examples, the flexible film or printed heater sheet can be layered or laid upon the base layer 122 (e.g., on an interior surface of the sensor cavity 112). In other examples, portions of the heater layer 124 may be embedded within the base layer 122 of the glare shield 114, laminated between layers, or otherwise disposed on an inner or outer surface thereof. The traces can be fabricated from resistive materials such as etched copper, nichrome, silver ink, or conductive carbon-based pastes. In one example, the heater layer 124 is printed or laminated onto a low-loss dielectric substrate such as polyimide, polyethylene terephthalate (PET), or thin glass, selected for its transparency (where desirable), heat resistance, and dielectric strength.

The heater assembly 124 may be powered by the vehicle's electrical system, with operating voltages ranging from 12 to 48 volts depending on vehicle configuration. Integrated temperature sensors, such as thermistors or resistance temperature detectors (RTDs), may monitor the surface temperature of the glare shield 114 and provide feedback to a control module. The control module may regulate the heater power through pulse-width modulation (PWM) or proportional-integral-derivative (PID) control algorithms to maintain an optimal temperature range that prevents condensation without overheating the surrounding components. In some examples, the heater assembly 124 may also be thermally segmented to independently heat localized zones within the sensor cavity 112, thereby prioritizing defogging of critical optical areas while conserving energy.

Although heater-based systems are effective for reducing condensation and frost buildup, the addition of complementary moisture-mitigation and demisting features can further enhance environmental control within the sensor cavity 112. Example moisture-mitigation and demisting features include, inter alia, air ventilation (whether ambient air or conditioned air from a heating, ventilation, and air conditioning (“HVAC”) system), passive desiccant cavities, microporous membranes, and/or moisture-absorption layers. Such features, which will be discussed in connection with the subsequent figures, can provide passive or hybrid thermal-moisture regulation, improve sensor reliability in humid or rapidly changing conditions, and reduce the need for continuous active heating.

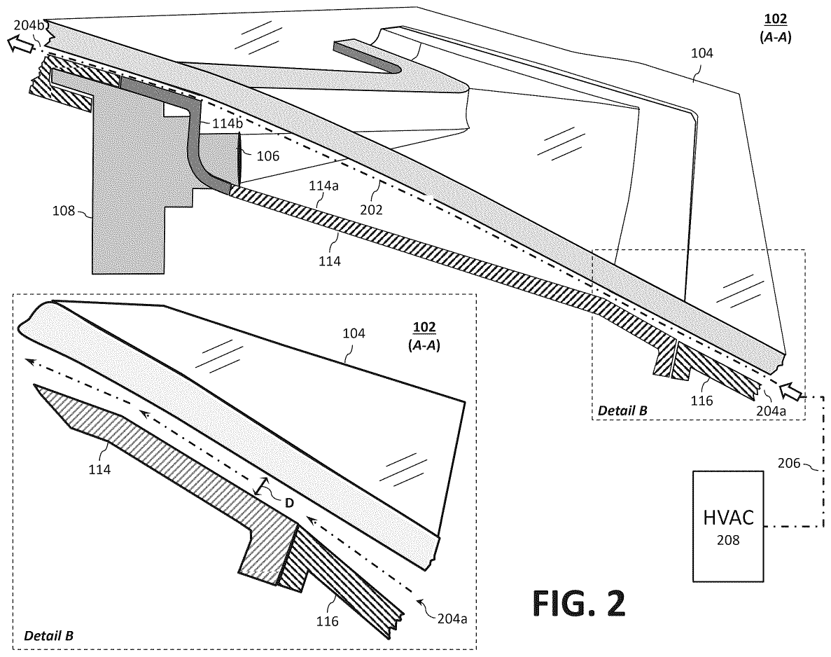

FIG. 2 illustrates an assembled cross-sectional side elevation view of a sensor system 102, in accordance with one aspect of the subject disclosure, taken along cut line A-A of FIG. 1a. The illustrated example depicts a sensor cavity 112 defined in part by a glare shield 114 and a transparent panel (or partially transparent panel), such as a portion of a windshield 104. The sensor cavity 112 is configured to enable the sensor payload 106 to detect environmental conditions external to the vehicle 100 (e.g., through a portion of the windshield 104) while maintaining protection against particulate ingress, such as dust and debris, as well as moisture intrusion. The geometry and sealing features of the glare shield 114 and adjacent structural members can be optimized to minimize optical distortion and reduce internal reflections that may otherwise degrade the accuracy or reliability of the sensor payload's optical or electromagnetic measurements. This will be described in greater detail in connection with the remaining figures.

In the illustrated example, the sensor cavity 112 includes one or more air vents, thereby allowing airflow 202 through the sensor cavity 112. The illustrated sensor cavity 112 is, therefore, not fully sealed relative to the environment. Rather, as shown, the airflow 202 can enter the sensor cavity 112 at an airflow inlet 204a, traverse the interior surface of the windshield 104, and exit the cavity at an airflow outlet 204b. With reference to Detail B of FIG. 2, the glare shield 114 and structural bracket 116 can be configured (e.g., contoured, or otherwise shaped) along one or more perimeter regions to define a controlled spacing (D) between the glare shield 114 (and/or structural bracket 116) and the windshield 104, thereby forming the airflow inlet 204a and airflow outlet 204b. In some examples, the spacing (D) can be tuned to achieve a desired flow rate or Reynolds number within the sensor cavity 112. Thus, ensuring sufficient convective heat transfer and preventing condensation on the interior windshield surface.

In addition to or in lieu of using the heat from the heater assembly 124, air within the sensor cavity 112 can be conditioned using airflow 202 supplied from a supply vent 206, which may be fluidically coupled to an HVAC unit 208, as one example. In another configuration, the airflow inlet 204a (either directly or via the supply vent 206) can be fluidically open to ambient air within the vehicle cabin. The HVAC unit 208 may be associated with or part of the vehicle's primary climate control system or a dedicated, localized HVAC component configured specifically for the sensor system 102.

In some examples, the conditioned airflow 202 can be actively delivered into the sensor cavity 112 via a fan or blower motor integrated with or controlled by the HVAC unit 208. In other examples, the airflow 202 may be passively induced through the sensor cavity 112 due to pressure differentials. For instance, a low-pressure region at the airflow outlet 204b can create suction that draws fresh airflow 202 through the cavity, maintaining circulation without active air supply. The geometries of the airflow inlet 204a and/or the airflow outlet 204b can be tuned to balance pressure drop and prevent reverse flow.

Several considerations can enhance the effectiveness of this airflow management system of FIG. 2. First, if the incoming airflow 202 is cold, effectiveness of the heating of the sensor cavity 112 via the heater assembly 124 may be reduced. Accordingly, it can be advantageous to supply airflow 202 that is preheated to maintain sensor operating temperature and prevent moisture (e.g., fog) accumulation. Example sources of heat include the HVAC unit 208, waste heat recovery from the engine, or other thermal management subsystems. Second, contamination control is relevant. To prevent degradation of sensor performance, the incoming airflow 202 may be filtered or otherwise purified prior to entering the sensor cavity 112. As discussed, this may include integration of particulate filters (e.g., HEPA-type), activated carbon filters for odor mitigation, or electrostatic precipitators positioned upstream of the airflow inlet 204a. Finally, to mitigate stray light or glare (light pollution) that could adversely affect the sensor payload 106, the sensor system 102 may incorporate optical baffles, light traps, and/or angled duct geometries at the airflow inlet 204a and/or airflow outlet 204b. These optical management features can preserve the reliability of the sensor's field of view while maintaining airflow performance.

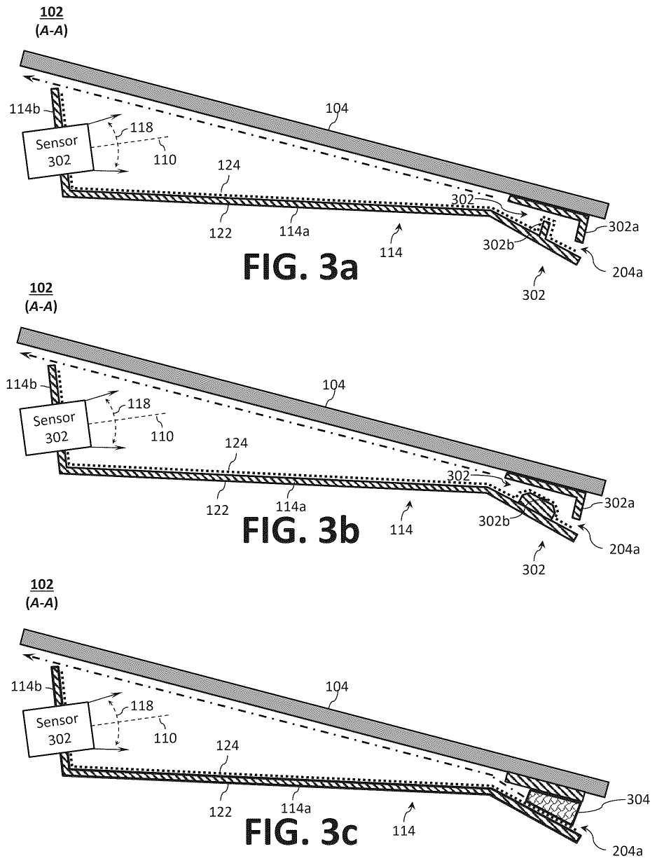

FIGS. 3a through 3c illustrate assembled cross-sectional side elevation views of the sensor system 102, taken along cut line A-A of FIG. 1a, in accordance with additional aspects of the subject disclosure. These examples illustrate variations in the geometric configuration of the glare shield 114, vent locations, and sealing arrangements. Collectively, these variations demonstrate alternative design examples intended to improve moisture management, airflow regulation, and light control within the sensor cavity 112. The illustrated configurations provide enhanced environmental resilience and optical performance, accommodating different installation constraints or desired operational characteristics.

FIG. 3a illustrates an example of the sensor system 102 configured to mitigate stray light, glare, and other sources of optical contamination. In this example, the sensor system 102 employs a labyrinth-style inlet configuration 302 designed to disrupt direct light paths into the system. The labyrinth structure 302 comprises a first light-baffle structure 302a (e.g., an upper light-baffle structure) and a second light-baffle structure 302b (e.g., a lower light-baffle structure) positioned adjacent to the inlet 204a. These structures are arranged to prevent a direct optical line-of-sight through the inlet 204a, thereby reducing or eliminating unwanted light intrusion.

Each of the illustrated first light-baffle structure 302a and second light-baffle structure 302b is configured as a planar projection (e.g., a wall-like extension). The first light-baffle structure 302a is coupled to the windshield 104 and extends toward the glare shield 114, leaving an air gap to permit airflow 202 into the sensor cavity 112. Conversely, the second light-baffle structure 302b is coupled to the glare shield 114 and extends toward the windshield 104, also maintaining a gap to allow for circulation airflow 202. The relative spacing between the two light-baffle structures allows sufficient air passage for ventilation and moisture control, while blocking or attenuating external light penetration through the inlet 204a and into the sensor cavity 112. Although the labyrinth configuration 302 is illustrated at the inlet 204a, similar labyrinth configurations 302 can be employed at the outlet 204b, either in addition to or as an alternative to a labyrinth configuration 302 at the inlet 204a.

As illustrated, the heater assembly 124 extends along the glare shield 114 and partially into the inlet 204a, serving to preheat incoming airflow 202 before it reaches the sensor cavity 112. This arrangement helps to ensure that condensation and moisture accumulation are minimized. Notably, the heater assembly 124 extends beyond the transparent portion of the sensor cavity 112 (i.e., the region visible through the windshield 104) into an area located beneath the non-transparent windshield region, such as a bracketed section associated with the first light-baffle structure 302a. This placement allows the heater to effectively condition airflow 202 entering from concealed regions.

FIG. 3b illustrates another example of the sensor system 102 configured to mitigate stray light, glare, and optical contamination. This configuration is substantially similar to that shown in FIG. 3a, except that the second light-baffle structure 302b is formed as a mound-shaped projection rather than a planar surface of FIG. 3a. This mounded geometry offers certain advantages. First, it increases the effective surface area in proximity to the heater assembly 124, improving thermal transfer to the passing airflow 202. The resulting slight reduction in airflow velocity within the mound region also allows the airflow 202 to absorb more heat, thereby enhancing preheating efficiency. Additionally, the mound continues to serve as an effective light barrier at the inlet 204a, maintaining the labyrinth's optical shielding function while improving environmental control.

FIG. 3C illustrates yet another example of the sensor system 102 designed for light, dust, and particle mitigation. In this example, instead of employing a labyrinth-type baffle configuration 302, a filter component 304 is positioned at the inlet 204a. The filter component 304 serves multiple functions, such as filtering particulates and blocking unwanted light penetration. Depending on design requirements, the filter component 304 can incorporate a range of passive air filtration media typically used in air handling or HVAC systems. These media can operate without external power, relying solely on airflow through the material to perform their function.

Example materials for the filter component 304 include, for example, plastic filters, fiberglass filters, pleated media filters, passive electrostatic (self-charging) filters, high efficiency particulate air (HEPA) filters, flock material, or the like. Plastic and fiberglass filters are economical elements that can be used for capturing large dust particles and debris. Pleated media filters, typically composed of polyester or cotton fibers, offer increased surface area and higher particle retention efficiency. Passive electrostatic (self-charging) filters utilize triboelectric effects to attract and retain airborne particles without external electrical input. The flock material can be configured with extended or longer fibers to diffuse and block incident light while simultaneously filtering dirt and debris from the airstream.

The filter component 304 may also incorporate adsorptive media designed to target gaseous contaminants and volatile organic compounds (VOCs) to further enhance air purity and odor control. Examples include activated carbon filters, which use adsorption mechanisms to remove smoke, odors, and VOCs from the airflow 202. In certain examples, zeolite-based filters or potassium permanganate-impregnated media can be employed to chemically neutralize specific gases such as ammonia, sulfur compounds, and formaldehyde. Zeolite-based filters operate through passive physical and chemical adsorption processes, requiring only normal airflow through the filter media.

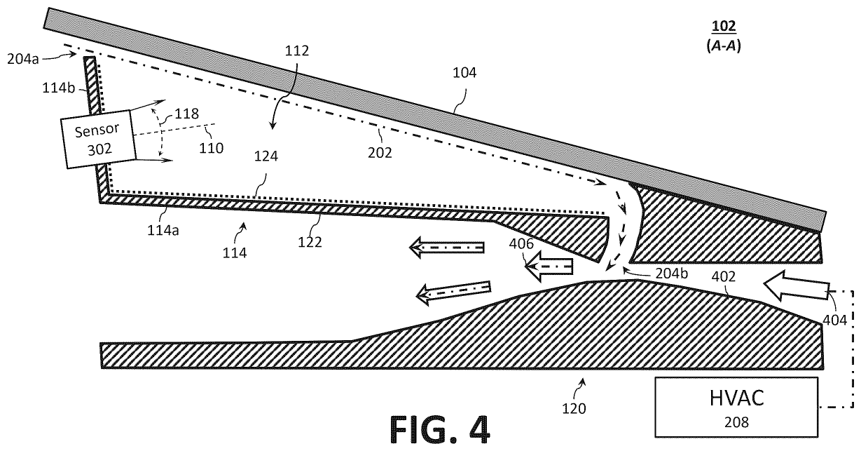

FIG. 4 illustrates an assembled cross-sectional side elevation view of the sensor system 102, taken along cut line A-A of FIG. 1a, in accordance with yet another aspect of the subject disclosure. The example shown in FIG. 4 is structurally and functionally like that described in connection with FIG. 3A, with the primary distinction being the reversal of the direction of the airflow 202 and the incorporation of a diffuser 402 in conjunction with an HVAC unit 208. In this configuration, the HVAC unit 208 operates to draw airflow 202 through the sensor cavity 112 via a controlled “suction effect.” Specifically, the HVAC unit 208 generates an air stream 404 that flows through and between the diffuser 402 and the underside of the glare shield 114. For example, the portion of the glare shield 114 oriented away from the windshield 104. The interaction between the air stream 404 and diffuser 402 creates a region of reduced static pressure adjacent to the sensor cavity 112, effectively functioning as a vacuum source.

The HVAC unit 208 may be configured or controlled to regulate the intensity of this air stream 404 such that the vacuum is sufficient to draw ambient or conditioned air (e.g., fresh air) through the sensor cavity 112. As a result of this induced airflow mechanism, fresh air enters the sensor cavity 112 through the airflow inlet 204a and is moved under differential pressure created by the HVAC unit 208 and the air stream 404. Within the sensor cavity 112, the airflow 202 traverses across the interior surface of the windshield 104. After traversing the sensor cavity 112, the airflow 202 exits through the airflow outlet 204b, where it merges with the air stream 404 generated by the HVAC unit 208. The combined flow forms an exhaust airflow 406, which may then be directed either into the vehicle cabin to supplement cabin ventilation or vented externally to the atmosphere.

In this example, a filter component 304, such as that described with reference to FIG. 3C, could be positioned at the airflow inlet 204a. As described above, the filter component 304 can include particulate and/or chemical filtration media for removing dust, odors, and volatile contaminants, ensuring that only clean, dry air enters the sensor cavity.

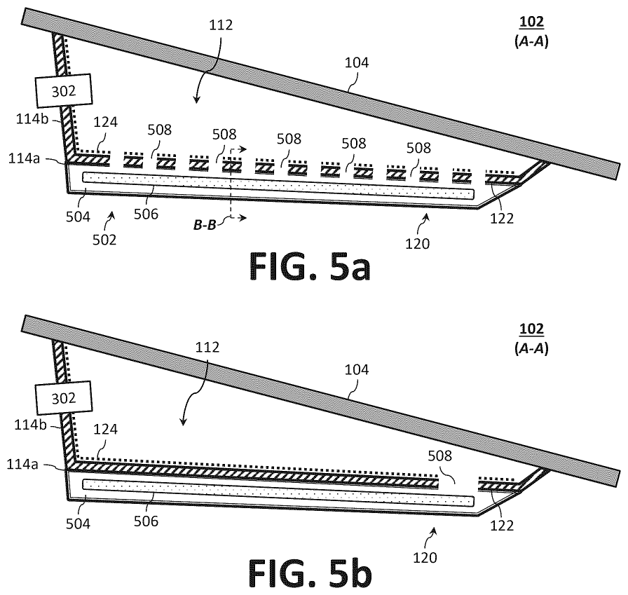

Referring now to FIGS. 5a through 7b, additional examples of the sensor system 102 are illustrated, incorporating moisture-mitigation and demisting features configured to operate in conjunction with, or independently of, a heater system. These additional features are designed to maintain optical clarity within the sensor cavity 112, particularly under conditions where condensation or humidity may accumulate faster than can be dissipated by heating alone, for example, during rapid temperature transitions, prolonged high humidity exposure, or when the vehicle 100 is powered off and passive protection is required. In these examples, the sensor cavity 112 is sealed (e.g., relative to the atmosphere), rather than using airflow as described in the prior examples. To that end, the glare shield 114 and structural bracket 116 (or other components of the housing assembly 120) can be sealed (e.g., with the windshield) along the entirety of the perimeter to define a sealed sensor cavity 112.

FIGS. 5a and 5b illustrate assembled cross-sectional side elevation views of a sensor system 102 incorporating moisture-absorption features 502, in accordance with additional aspects of the subject disclosure, taken along cut line A-A of FIG. 1a. As illustrated, the moisture-absorption features 502 can take different forms depending on design and packaging constraints. In one example, the moisture-absorption feature 502 is configured as a moisture cavity 504 defined by and/or integrated with the glare shield 114 (or another component of the housing assembly 120). The moisture cavity 504 is configured to house a moisture-trapping material 506, such as a desiccant, sponge, or other material exhibiting hygroscopic properties. The moisture-trapping material 506 serves to absorb water vapor accumulating within the sensor cavity 112, thereby mitigating condensation on, for example, the windshield 104.

In the illustrated example, the sensor system 102 therefore includes a moisture-absorption feature 502, which may take the form of a moisture cavity 504 integrated within or adjacent to the glare shield 114. To allow for movement of air between the sensor cavity 112 and the moisture cavity 504, one or more vent openings 508 are formed in, for example, the glare shield 114 (e.g., in the first glare panel 114a and/or the second glare panel 114b). The one or more vent openings 508 can be configured in the first glare panel 114a and/or the second glare panel 114b as holes (e.g., round holes), slits or slots (e.g., linear opening), or the like.

The moisture cavity 504 can be at least in part defined by the walls of the glare shield 114, such as the first glare panel 114a and second glare panel 114b, or by a recess formed at a sealed interface between the glare shield 114 and the windshield 104. The moisture cavity 504 is configured to house a moisture-trapping material 506, which may include a desiccant medium and/or a hygroscopic composite material.

In one example, the moisture-trapping material 506 comprises a desiccant such as silica gel, zeolite, activated alumina, or calcium chloride beads contained within a porous carrier matrix. In other examples, the moisture-trapping material 506 may include a polymeric material with hydrophilic characteristics, such as polyvinyl alcohol (PVA), nylon-6, or a superabsorbent hydrogel composite capable of adsorbing and releasing moisture as ambient conditions fluctuate. The desiccant may be encapsulated within a microperforated film or textile pouch to prevent particle migration while maintaining vapor permeability. In still further examples, the desiccant-containing moisture cavity 504 can be designed as a replaceable or serviceable module, allowing periodic regeneration or replacement during vehicle maintenance.

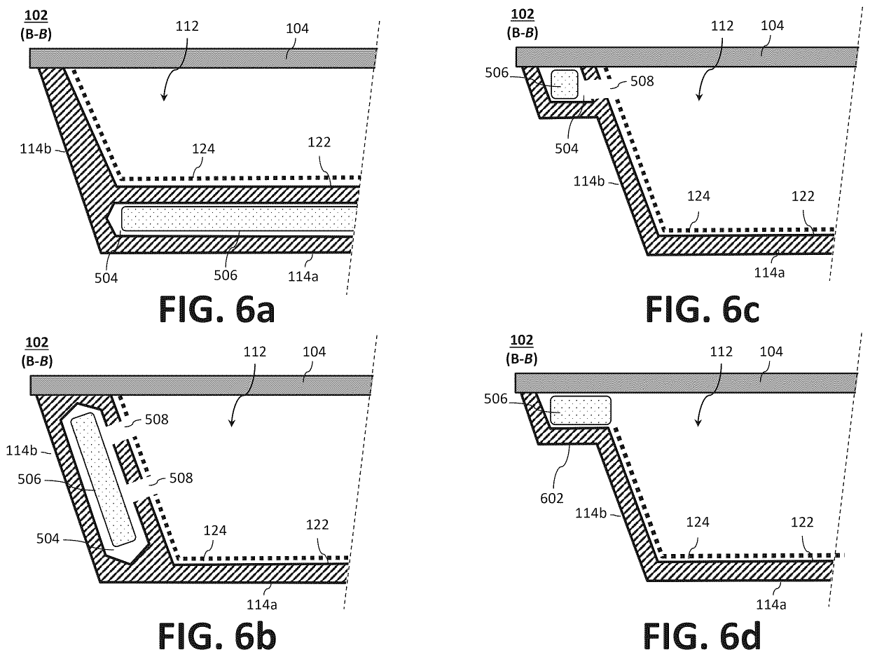

FIGS. 6a through 6d illustrate assembled cross-sectional side elevation views of example arrangements for the moisture-absorption feature 502, in accordance with additional aspects of the subject disclosure, taken along cut line B-B of FIG. 5a. In these examples, the moisture cavity 504 may be formed in, on, or adjacent to various surfaces of the glare shield 114, including a first glare panel 114a, a second glare panel 114b, and/or at a sealed interface between the glare shield 114 and the windshield 104. The placement and shape of the moisture cavity 504 can be optimized to promote airflow and moisture transport between the sensor cavity 112 and the moisture-trapping region, thereby improving the desiccation efficiency and reducing the likelihood of condensation formation on critical optical components. For instance, the cavity may be embedded within the first glare panel 114a, formed on the rear surface of the second glare panel 114b, or integrated within a junction region between the glare shield 114 and windshield 104. Each configuration is designed to promote capillary-driven or diffusive transfer of water vapor from the sensor cavity 112 toward the moisture cavity 504, establishing a humidity gradient that continuously draws moisture away from the optical path.

FIG. 6a illustrates an example in which the moisture cavity 504 and the moisture-trapping material 506 are formed within or adjacent to the first glare panel 114a.

FIG. 6b illustrates an example in which the moisture cavity 504 and the moisture-trapping material 506 are formed within or adjacent to the second glare panel 114b. In some examples, a moisture cavity 504 and a moisture-trapping material 506 can be formed within or adjacent to both the first glare panel 114a and the second glare panel 114b.

FIG. 6c illustrates an example in which the moisture cavity 504 and the moisture-trapping material 506 are formed within or adjacent to the second glare panel 114b positioned adjacent to the windshield 104.

FIG. 6d illustrates an example in which the second glare panel 114b forms a ledge 602 along the perimeter of the glare shield 114 where it interfaces with the windshield 104. For example, the glare shield 114 can be adhered to the windshield 104 such that the sensor cavity 112 is sealed. To manage moisture, the moisture-trapping material 506 can be positioned on or adjacent to the ledge 602. In some examples, the ledge 602 can be positioned such that it (and any associated moisture-trapping material 506) are not visible through the windshield 104. For instance, a bezel or glass laminate can be used to visually obscure the ledge 602, or the ledge 602 can be located behind a structural bracket 116 or a similar component.

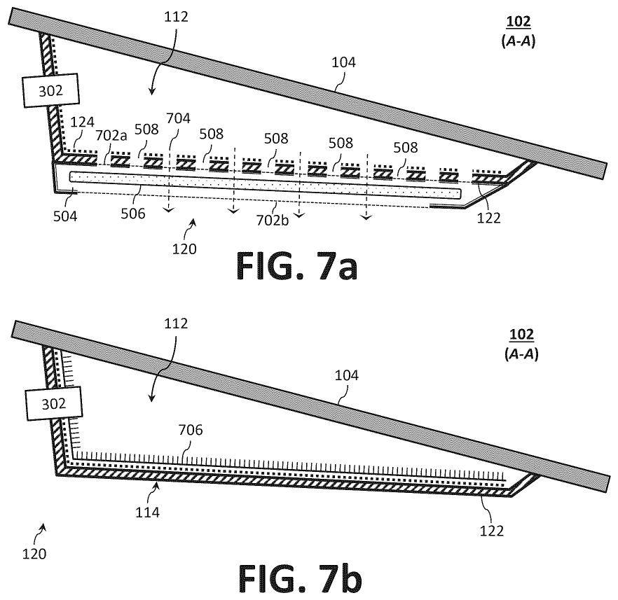

FIGS. 7a and 7b illustrate assembled cross-sectional side elevation views of a sensor system 102 including, respectively, a microporous layer 702 and a moisture-absorption layer 706, in accordance with additional aspects of the subject disclosure, taken along cut line A-A of FIG. 1A. These examples demonstrate alternative or complementary moisture-management strategies incorporated into the sensor system 102.

The sensor system 102 of FIG. 7a is substantially similar to that shown in FIG. 5a, except that the vent openings 508 may be covered or sealed by one or more microporous membranes 702. The microporous membranes 702 permit the one-way passage of water vapor (e.g., moisture) into the moisture cavity 504 as indicated by arrow 704, while preventing particulate contamination. The microporous membrane 702 may be fabricated from expanded polytetrafluoroethylene (ePTFE), polypropylene, or a polyurethane-based hydrophobic-oleophobic film. Commercial examples include waterproof, breathable materials such as Gore-Tex® or Sympatex®.

In certain examples, the sensor system 102 may employ two microporous layers 702a and 702b. The first microporous layer 702a is disposed adjacent to vent openings 508 within the glare shield 114, providing a barrier between the sensor cavity 112 and the moisture cavity 504. This layer enables controlled vapor transfer (as indicated by arrows 704) while ensuring that no liquid condensate re-enters the sensor cavity 112. The second microporous layer 702b may be positioned along the outer boundary of the moisture cavity 504, enabling vapor to escape the moisture cavity 504 and into the exterior environment or cabin air. Together, the first and second microporous layers 702a, 702b provide an effective one-way humidity evacuation while maintaining a sealed sensor cavity 112.

In another example, shown in FIG. 7b, the sensor system 102 includes a moisture-absorption layer 706 formed on an interior surface of the glare shield 114 within the sensor cavity 112. The moisture-absorption layer 706 may comprise a thin textile or composite layer configured to temporarily retain moisture through capillary action or surface adsorption. Suitable materials include microfleece, nonwoven felt, or electrostatically flocked fabrics, wherein short fibers are vertically oriented and bonded to a base substrate using adhesive. The fiber density, length, and material composition may be selected to balance absorption rate and evaporation efficiency. For instance, a polyester-nylon blend flock layer may absorb transient condensation during rapid cooling and gradually release it as the heater system reactivates, thereby preventing droplet formation on optical surfaces.

In certain examples, the moisture-absorption layer 706 may be treated with hydrophilic surface coatings to enhance capillary spreading of moisture films, enabling faster drying and more uniform evaporation. Example hydrophilic surface coatings include titanium dioxide (TiO₂) or polyethylene glycol (PEG) derivatives. Alternatively, or additionally, a porous ceramic coating or graphene oxide film may be employed.

While the present method and/or system has been described with reference to certain examples, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular examples disclosed. Instead, the present method and/or system will include all examples falling within the scope of the appended claims, both literally and under the doctrine of equivalents.

What is claimed is:

1. A sensor system for use with a windshield that defines an at least partially transparent region, the sensor system comprising:
a glare shield configured to be positioned adjacent to the windshield to define a sensor cavity therebetween; and
at least one sensor configured to be disposed within the sensor cavity and oriented with a field of view through the at least partially transparent region of the windshield,
wherein the glare shield defines an airflow path through the sensor cavity between an airflow inlet and an airflow outlet to mitigate moisture accumulation within the sensor cavity.

2. The sensor system of claim 1, further comprising a heating, ventilation, and air conditioning (HVAC) unit configured to direct airflow along the airflow path.

3. The sensor system of claim 2, wherein the HVAC unit is configured to generate an air stream that induces a pressure differential across the sensor cavity.

4. The sensor system of claim 1, further comprising a diffuser positioned proximate to the airflow outlet configured to draw air through the sensor cavity.

5. The sensor system of claim 1, further comprising a heater assembly disposed adjacent to the glare shield and configured to preheat airflow entering the sensor cavity.

6. The sensor system of claim 1, further comprising at least one filter component positioned at the airflow inlet and configured to filter airflow at the airflow inlet.

7. The sensor system of claim 6, wherein the filter component comprises at least one of: a fiberglass filter, a pleated media filter, a passive electrostatic filter, or a HEPA filter.

8. The sensor system of claim 1, wherein the sensor cavity includes a light-baffle structure configured to block light at the airflow inlet.

9. The sensor system of claim 1, wherein the airflow path traverses along an interior surface of the windshield to reduce fogging or condensation at the at least partially transparent region.

10. The sensor system of claim 2, wherein the HVAC unit is configured to regulate at least one of airflow velocity, temperature, and/or direction through the sensor cavity.

11. A sensor system for use with a windshield that defines an at least partially transparent region, the sensor system comprising:
a glare shield configured to be positioned adjacent to the windshield to define a sealed sensor cavity therebetween;
at least one sensor configured to be disposed within the sealed sensor cavity and oriented with a field of view through the at least partially transparent region of the windshield; and
a moisture-trapping material disposed within the sealed sensor cavity and configured to absorb or adsorb moisture to control humidity and reduce condensation within the sealed sensor cavity.

12. The sensor system of claim 11, wherein the moisture-trapping material comprises silica gel, molecular sieve materials, zeolite, activated alumina, or calcium chloride-based desiccants.

13. The sensor system of claim 11, wherein the moisture-trapping material is contained within a permeable enclosure or vented housing positioned in a lower region of the sealed sensor cavity to facilitate passive humidity control.

14. The sensor system of claim 11, further comprising a vapor-permeable membrane disposed within the sealed sensor cavity, the vapor-permeable membrane being configured to allow water vapor transmission toward the moisture-trapping material.

15. The sensor system of claim 11, wherein the sealed sensor cavity is defined by a continuous seal between the glare shield and the windshield to prevent external fluid ingress.

16. The sensor system of claim 11, further comprising a heater assembly configured to raise a temperature within the sealed sensor cavity.

17. The sensor system of claim 11, wherein the at least one sensor is a camera, lidar sensor, or infrared detector.

18. A housing assembly for a sensor system configured for use with a windshield having an at least partially transparent region, the housing assembly comprising:
a glare shield configured to be positioned adjacent to the windshield to define a sealed sensor cavity therebetween,
wherein the glare shield comprises a first glare panel and a second glare panel oriented transversely relative to one another,
wherein each of the first glare panel and the second glare panel comprises a heater layer configured to provide a dual-plane heater arrangement,
wherein at least one sensor is configured to be disposed within the sealed sensor cavity and oriented with a field of view through the at least partially transparent region of the windshield, and
wherein the sealed sensor cavity is defined by a continuous seal between the glare shield and the windshield to prevent external fluid ingress.

19. The housing assembly of claim 18, further comprising a moisture-trapping material disposed within the sealed sensor cavity and configured to absorb or adsorb moisture in the sealed sensor cavity.

20. The housing assembly of claim 19, wherein the moisture-trapping material is contained within a permeable enclosure or vented housing positioned of the sealed sensor cavity to facilitate passive humidity control.
